(19) United States
(12) Patent Application Publication
(10) Pub. No.: US 2026/0023932 A1
(43) Pub. Date: Jan. 22, 2026

(54) USING ARTIFICIAL INTELLIGENCE TO PREPARE PRIORITY-BASED RESPONSES

(71) Applicant: International Business Machines Corporation, Armonk, NY (US)

(72) Inventors: Sanket Jain, Gurgaon (IN); GOTETI BHASKAR, Hyderabad (IN); SUKUMAR BERI, New Delhi (IN); Ratnakar Behera, Bangalore (IN); Saurabh Kochhar, New Delhi (IN); Jasbir Singh Dhaliwal, Noida (IN); Ayaskanta Panigrahi, Bhadrak (IN)

(21) Appl. No.: 18/779,474

(22) Filed: Jul. 22, 2024

(51) Int. Cl. G06F 40/35; H04L 51/02

(52) U.S. Cl. CPC G06F 40/35; H04L 51/02

(57) ABSTRACT

According to one embodiment, a method, computer system, and computer program product for assisting with priority-based responses to requests is provided. The embodiment may include analyzing one or more conversations, wherein analyzing includes identifying data from within the one or more conversations, wherein the data includes at least one request and at least one response. The embodiment may also include training a machine learning model on the identified data using long short-term memory with layer-wise relevance propagation. The embodiment may further include assisting a user in responding with a new response to a new request using the trained model.

### BACKGROUND

The present invention relates generally to the field of computing, and more particularly to communication systems.

Modern telecommunications enable users to communicate across the globe, instantly, conveniently, and cheaply. However, these conveniences come with social complexities distinct from in-person interactions. Emphasis is not immediately clear in text-based interactions, and tonal implications, such as those signaling sarcasm, can easily be misunderstood. The context provided by body language can be lost in audio and even video interactions. Accordingly, modern communication systems provide various tools, including formatting, emoticons, audio messages, images, and multi-media interactions to facilitate clear, effective communications.

### SUMMARY

According to one embodiment, a method, computer system, and computer program product for assisting with priority-based responses to requests is provided. The embodiment may include analyzing one or more conversations, wherein analyzing includes identifying data from within the one or more conversations, wherein the data includes at least one request and at least one response. The embodiment may also include training a machine learning model on the identified data using long short-term memory with layer-wise relevance propagation. The embodiment may further include assisting a user in responding with a new response to a new request using the trained model.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a process for preparing priority-based responses.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to communication systems. The following described exemplary embodiments provide a system, method, and program product to, among other things, assist users in preparing tactful, well-reasoned responses to work-related requests. Therefore, the present embodiment has the capacity to improve the technical field of communications by assisting users in navigating precarious work situations with tactful language and reasoning.

As previously described, modern telecommunications enable users to communicate across the globe, instantly, conveniently, and cheaply. However, these conveniences come with social complexities distinct from in-person interactions. Emphasis is not immediately clear in text-based interactions, and tonal implications, such as those signaling sarcasm, can easily be misunderstood. The context provided by body language can be lost in audio and even video interactions. Accordingly, modern communication systems provide various tools, including formatting, emoticons, audio messages, images, and multi-media interactions to facilitate clear, effective communications.

Communication in work scenarios can be particularly complex, rife with nuance and complex relationships. For example, many people find themselves needing to find polite ways to turn down requests from managers or clients, or re-prioritize work around such requests. While communicating effectively in such circumstances is extremely important, typical Natural Language Processing (“NLP”) techniques are of limited help in navigating such nuanced situations. As such, it may be advantageous to combine use of a machine learning (“ML”) model trained with Long Short-Term Memory (“LSTM”) and other techniques, such as Layer-wise Relevance Propagation (“LRP”), in order to assist users in responding to nuanced requests.

According to one embodiment, a priority request response program analyzes one or more conversations for requests and responses. The priority request response program then trains an Assisted Response Decision model (“ARDM”) based on the analyzed conversations using LSTM and LRP. The priority request response program then uses the ARDM to assist a user in responding to a request.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

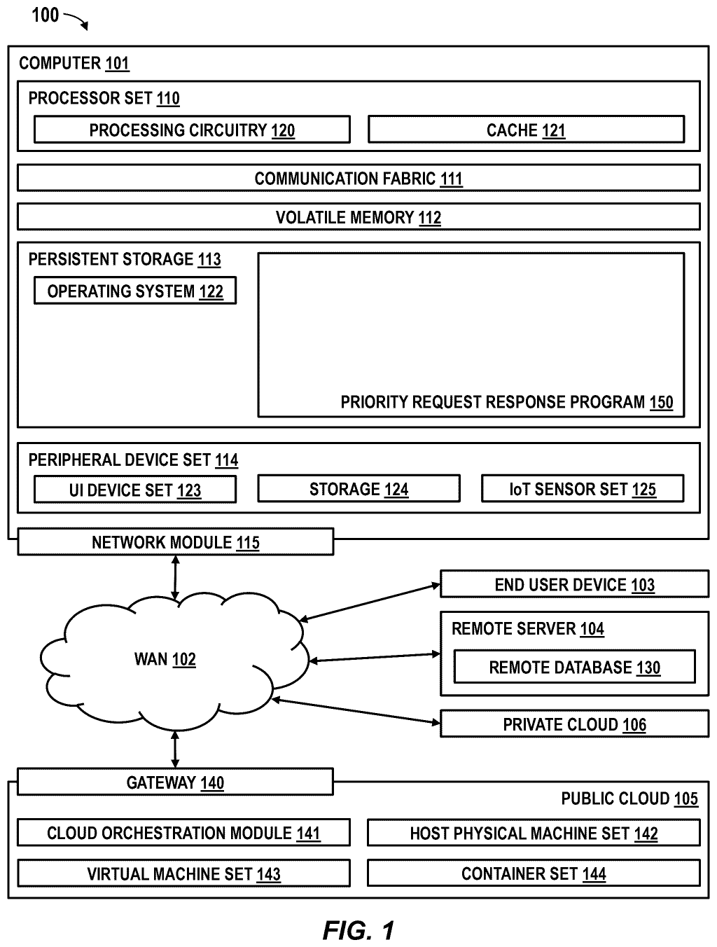

Referring now to FIG. 1, computing environment 100 contains an example of an environment for the execution of at least some of the computer code involved in performing the inventive methods, such as priority request response program 150. In addition to priority request response program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and priority request response program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in priority request response program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in priority request response program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth® (Bluetooth and all Bluetooth-based trademarks and logos are trademarks or registered trademarks of the Bluetooth Special Interest Group and/or its affiliates) connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The priority request response program 150 may identify requests and responses in one or more conversations. The priority request response program 150 may then train a machine learning model based on the conversations using LSTM and LRP. The priority request response program 150 use the trained model to assist a user in responding to a request.

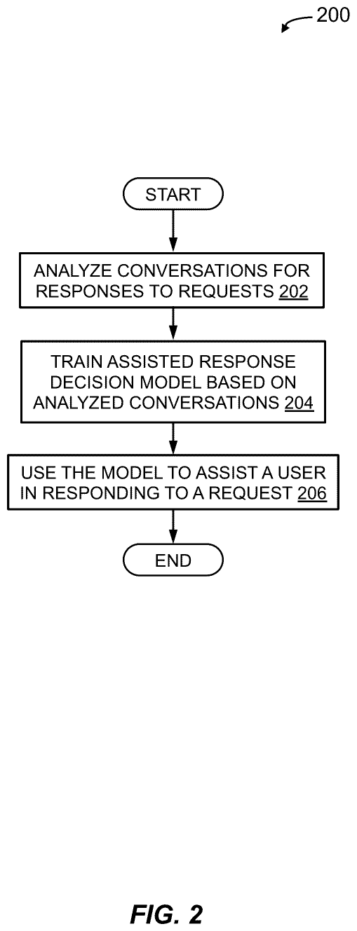

Furthermore, notwithstanding depiction in computer 101, priority request response program 150 may be stored in and/or executed by, individually or in any combination, end user device 103, remote server 104, public cloud 105, and private cloud 106. The data management method is explained in more detail below with respect to FIG. 2.

Referring now to FIG. 2, an operational flowchart for a process for preparing priority-based responses 200 is depicted according to at least one embodiment. At 202, the priority request response program 150 analyzes one or more conversations for requests and responses. Analyzing may include identifying conversations, requests, responses, and contextual information, including information about the participants in the conversations, or processing such information to identify new information. A conversation may include, for example, a text-based conversation, such as a chat conversation or email conversation, a voice conversation, a conversation through visual media, or a mixed media conversation. A conversation may include any number of participants, including coworkers, friends, clients, customers, adversarial parties, or any other combination of participants. Requests may include, in addition to typical requests, suggestions, orders, demands, or any other type of request. Responses may include various types of affirmative or negative response with conditions or context. Data may be identified according to opt-in procedures.

Analyzing may include identifying conversations, requests, responses, and contextual information, including information about the participants in the conversations, or processing such information to identify new information. Analyzing may be performed using NLP techniques, including simple NLP techniques such as statistical analysis and artificial intelligence-based techniques, such as sentiment analysis and artificial neural networks. Analyzing may further include linking data from disparate sources: for example, if two users on an instant messaging platform mention an email discussion, analyzing may include identifying context from both the email conversation and the instant messaging conversation and connecting them to inform one another. Analyzing may further include identifying the participants in the conversation and information from their job profiles or from any other source that the priority request response program 150 may have access and permission to use.

As a further example of analyzing using artificial intelligence techniques, analyzing may include using a trained machine learning model, including a preexisting model, or a model trained using any of the data collected at 202 or any other relevant data, or any of the methods described at 204 or any other relevant methods. Analyzing data may further include processing audio data, such as by speech-to-text, or analyzing visual data, such as by computer vision techniques.

Analyzing may include analysis at a variety of scales, including sentence analysis, analysis at the scale of a full conversation, and analysis at the scale of an individual message. Sentence analysis may be performed, for example, by a universal sentence encoder, and may include other NLP methods such as sentiment analysis.

A conversation may include, for example, a text-based conversation, such as a chat conversation, email conversation, or forum-based conversation; a voice conversation; a conversation through visual media; or a mixed media conversation. Voice conversations may include voice notes or live voice interactions. Visual media may include a video or video stream, an emoticon, a photograph or still image including a generated image, or an animated image, such as a .GIF file. Mixed media conversations may include any combination of these or any other media. Examples of conversation media may include email, instant messaging, and video chat, and may be transmitted through various means, including networks such as the internet, a local area network, or a virtual private network.

A conversation may include any number of participants, including coworkers, friends, clients, customers, adversarial parties, or any other combination of participants. A request may be made by one or more requesting users and one or more recipients or respondents. For example, if user A sends the following message to a chat room asking for a note-taker: “user B and I were wondering if anybody could help us take notes on tomorrow's meeting,” the requesting users may be identified as user A and user B, and the request recipients may be identified as every participant in the chat besides user A and user B, and users who actually respond to the request may be identified as respondents.

Analyzing a conversation may include identifying information about the participants, as discussed above, and their relationships. For example, a company's internal job profile system may include a job title, job description, location, time zone, and organization chart. An organization chart may be used, alone or in combination with other data, to determine a relationship between two coworkers. As another example, if an employee A of company A is exchanging emails with an employee B with an email address from company B, and the employee A is noted in the system as a customer support agent based on job description, and company B is known to have a contract for support from company A, and the context of the emails signifies that they may be technical support emails, the roles of employee A and employee B may be determined to be a technical support provider and a technical support client, respectively.

Requests may include, in addition to typical requests, suggestions, instructions, orders, demands, or any other type of request, including work and personal requests. Requests may be categorized according to these or other criteria. For example, requests may be divided into categories based on grammatical format, such as questions and imperatives, or by tone, such as polite requests, firm requests, and urgent requests. Requests may be analyzed in a variety of ways, such as by rating sentiment using NLP with sentiment analysis, or by scoring urgency on a scale of 0 to 1.

Responses may include various types of affirmative, negative, or mixed response with conditions or context, and may be framed in various categories, or analyzed to create new information about the responses. For example, responses that are first categorized as affirmative (or “yes” response), negative (or “no” response), or mixed (“unsure,” “maybe,” and similar responses), may further be categorized into subcategories such as positive yes, qualified yes, high priority, unsure, low priority, polite no, upset no, or material no. A material no, for example, may signify a negative response with an explanation of circumstances. A qualified yes may include a yes with conditions, such as time-based conditions, or a grammatical yes that only accepts part of the request, and rejects part of the request. A priority response, such as a high priority, low priority, or questioning priority response may indicate that the recipient of the request has a complex schedule that needs to be addressed in particular ways. The priority request response program 150 may further identify instances of users not responding to a request at all, for example intentionally ignoring the request, or identify cases of users not responding to a request in time for the request to be relevant.

Priority-based responses may include, for example, a respondent discussing timing and prioritization of the request with the requesting user; sharing a task list, calendar, or schedule; discussing other priorities, such as, for example, deprioritizing another task in order to prioritize the request; discussing assistance, overtime pay or similar conditions that might help to accommodate new tasks in a short time; or discussing how long a task might take to complete.

Conversation data may further include feedback collected at 206.

Conversation data may be identified and analyzed continuously, or at any frequency, at any stage in the process for preparing priority-based responses 200. Any data that has been identified or analyzed at 202 may be referred to as “analyzed conversation data.”

Then, at 204, the priority request response program 150 trains a machine learning model by LSTM and LRP, using the analyzed conversation data. The machine learning model may be referred to as an ARDM.

LSTM may include various types of LSTM, including, in a preferred embodiment, bidirectional LSTM (or biLSTM). A bidirectional LSTM may include an input layer, forward layer, backwards layer, activation layer, and output layer. In alternate embodiments, the model may be trained using any other LSTM or deep recurrent neural network (“RNN”), or other techniques, particularly learning techniques that overcome the vanishing gradient problem.

LSTM and similar training methods may be used to analyze intent behind why a particular response was given. For example, LSTM may be used to determine why an employee firmly rejected a request from their manager.

LRP may include various types of LRP, including, in a preferred embodiment, epsilon-LRP (or E-LRP). ¿-LRP may include use of a small constant in a denominator used to reduce the effect of outliers on an LRP algorithm, create sparse explanations, or reduce noise. In an alternate embodiment, an LRP may include gamma-LRP, LRP-0, or alpha-beta-LRP. LRP may assist in producing an explanation that functions as accurate representation of an output neuron of interest, and may also assist in making the explanation easy for humans to interpret.

In a preferred embodiment, the ARDM may be trained specifically by combining bi-LSTM with E-LRP.

The ARDM may be trained all at once or incrementally. For example, the ARDM may be trained on an initial set of data and used at 206, and then trained incrementally, repeatedly, or continuously as more data is collected at 202.

Then, at 206, the priority request response program 150 uses the ARDM to assist a user in responding to a request. The request and response may include any type of request or response described at 202. Assisting a user may include, for example, generating a response, modifying a response written by a user, converting a response to a different format, providing reasoning to explain a response, making recommendations to a user to assist with a response, or any other form of assistance. The priority request response program 150 may further collect feedback regarding the assistance it provides.

In at least one embodiment, assisting a user may include, for example, generating a response, or generating multiple responses for a user to choose between. A generated response may then be sent or further modified by a user. Assisting may further include programmatically modifying a response written by a user, or making recommendations for a user to modify a response.

In further embodiments, assisting may include converting a response to a different format, such as by text-to-speech or speech-to-text. As another example, assisting may include suggesting that a user replace an emoticon with a word, or vice-versa.

In another embodiment, assisting may include providing reasoning to explain a response. For example, if a user begins to type, “sorry, I don't think I'll have the time this week,” the ARDM may generate an additional text briefly explaining other tasks this week that must take priority for the respondent. Such generating may, for example, include use of tone analysis to ensure that the additional text is consistent in tone to the initial text. Generating may additionally be performed with the assistance of any other large language model or generative artificial intelligence technique.

Assistance may be presented to a user through a user interface in a dedicated program or integrated into a messaging program. Such an interface may, for example, present multiple choices to a user as message templates, as suggested text, as a popup suggestion for a modification, a red underline or similar formatting to indicate that a word should be avoided, or through any other interface that may be used to assist a user.

In at least one embodiment, a generated response may be generated according to a known writing style of the respondent, or according to the preferences of a requesting user. For example, if the requesting user is a manager, and the respondent is the employee, and the priority request response program 150 determines that the manager prefers short, succinct responses, the ARDM may generate a short response, or recommend that a user provide a short response. The priority request response program 150 may account for writing style, sentiment, tone, relationships between users, or any other stylistic or tactful factor in assisting a user as determined by the ARDM, or assisting algorithms or models using techniques such as tone analysis and sentiment analysis.

For example, the priority request response program 150 may determine that more tactful responses are generally necessary for users responding to managers or clients, but more direct responses may be appropriate in some cases where responding to peers, to friends, or to particular managers who are identified as responding positively to direct responses. The priority request response program 150 may further identify risks, such as a risk that a requesting user misunderstands a response, for example due to a language barrier issue.

In further embodiments, assistance may include automatically sending a response or other communication. For example, if a user sends a positive response based on assistance provided, the priority request response program 150 may further send a reaction response of a thumbs up to a request message, indicating that the user has accepted the request in the request message.

Requests and responses may include any type of request or response described at 202. Particularly, responses may include any form of positive, negative, or mixed response. As a specific example, if a user types, “sorry,” the priority request response program 150 may provide assistance by presenting a user with a schedule on a relevant time scale for the request, and auto-complete a response starting with “sorry” that explains difficulties in prioritizing the request. As another example, under a request, the priority request response program 150 may display bubbles for general categories “yes,” “no,” and “maybe . . . ” and, upon selecting “maybe,” the priority request response program 150 may automatically generate a “maybe” response with reasoning explaining why the user may or may not be able to complete the request.

The priority request response program 150 may assist any number of users with any number of responses in any combination of the above ways. Assistance may be provided to users at any time during the process for preparing priority-based responses 200.

The priority request response program 150 may further collect feedback regarding the assistance it provides. Collecting feedback may include, for example, prompting a user to rate the assistance provided or comparing the response a user decides to send with the assistance given to the user. Collected feedback may be used to further train the ARDM or any other machine learning model used during the process for preparing priority-based responses 200. Feedback may further be provided by a requester or any user who views a response.

It may be appreciated that FIG. 2 provides only an illustration of one implementation and does not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
identifying data from one or more conversations, wherein the data includes at least one request and at least one response;
training a machine learning model on the identified data using long short-term memory with layer-wise relevance propagation; and
assisting a user in responding with a new response to a new request using the trained model.

2. The method of claim 1, wherein training the machine learning model is further performed using bidirectional long short-term memory with layer-wise relevance propagation.

3. The method of claim 2, wherein training the machine learning model is further performed using bidirectional long short-term memory with epsilon layer-wise relevance propagation.

4. The method of claim 1, wherein assisting the user includes providing reasoning about the new response.

5. The method of claim 1, further comprising:
collecting feedback about the assisting;
further training the model based on the collected feedback.

6. The method of claim 1, wherein identifying data further includes analyzing the data using sentiment analysis.

7. The method of claim 1, wherein assisting the user includes generating the new response using a large language model.

8. A computer system, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
identifying data from one or more conversations, wherein the data includes at least one request and at least one response;
training a machine learning model on the identified data using long short-term memory with layer-wise relevance propagation; and
assisting a user in responding with a new response to a new request using the trained model.

9. The computer system of claim 8, wherein the training the machine learning model is further performed using bidirectional long short-term memory with layer-wise relevance propagation.

10. The computer system of claim 9, wherein the training the machine learning model is further performed using bidirectional long short-term memory with epsilon layer-wise relevance propagation.

11. The computer system of claim 8, wherein assisting the user includes providing reasoning about the new response.

12. The computer system of claim 8, further comprising:
collecting feedback about the assisting;
further training the model based on the collected feedback.

13. The computer system of claim 8, wherein identifying data further includes analyzing the data using sentiment analysis.

14. The computer system of claim 8, wherein assisting the user includes generating the new response using a large language model.

15. A computer program product, the computer program product comprising:
one or more computer-readable tangible storage media and program instructions stored on at least one of the one or more tangible storage media, the program instructions executable by a processor capable of performing a method, the method comprising:
identifying data from one or more conversations, wherein the data includes at least one request and at least one response;
training a machine learning model on the identified data using long short-term memory with layer-wise relevance propagation; and
assisting a user in responding with a new response to a new request using the trained model.

16. The computer program product of claim 15, wherein the training the machine learning model is further performed using bidirectional long short-term memory with layer-wise relevance propagation.

17. The computer program product of claim 16, wherein the training the machine learning model is further performed using bidirectional long short-term memory with epsilon layer-wise relevance propagation.

18. The computer program product of claim 15, wherein assisting the user includes providing reasoning about the new response.

19. The computer program product of claim 15, further comprising:
collecting feedback about the assisting;
further training the model based on the collected feedback.

20. The computer program product of claim 15, wherein identifying data further includes analyzing the data using sentiment analysis.
